(19) United States
(12) Patent Application Publication
(10) Pub. No.: US 2013/0186823 A1
(43) Pub. Date: Jul. 25, 2013

(54) METHOD FOR THE ACIDIFICATION OF MANURE

(71) Applicant: Red Patent B.V., Gorssel (NL)

(72) Inventor: Jacob Hendrik Obbo HAZEWINKEL, ZOETERMEER (NL)

(73) Assignee: RED PATENT B.V., GORSSEL (NL)

(21) Appl. No.: 13/784,859

(22) Filed: Mar. 5, 2013

Related U.S. Application Data
(63) Continuation of application No. PCT/EP2010/063105, filed on Sep. 7, 2010.

(51) Int. Cl. C02F 3/28

(52) U.S. Cl. CPC C02F 3/28
USPC 210/604; 210/603

(57) ABSTRACT

By acidifying manure, emissions of methane gas and ammonia gas are prevented significantly. The method for the acidification of manure is provided by an acidic flow of an anaerobic digestion device and/or the flow of sulphuric and/or sulphurous acid from a device that removes hydrogen sulphide gas from biogas from an anaerobic digestion device by chemical and/or biological oxidation to sulphuric acid. When manure is digested, acidification has the advantage that more methane is formed in the digestion process by the prevention of the formation of methane by acidification in the storage process, the advantage that the part of ammonia that would be emitted as a gas is now stored as a nitrogen mineral in the digested manure for use as fertilizer, and the advantage is that the manure has a pH value that is more preferable for digestion processes in the case the manure will be digested.

### CROSS REFERENCE TO RELATED APPLICATIONS

This application is a continuation of PCT application number PCT/EP2010/063105 filed on 7 Sep. 2010. This application is hereby incorporated by reference in its entirety.

### BACKGROUND OF THE INVENTION

1. Field of the Invention

The invention relates generally to a method for the acidification of manure.

2. Description of the Related Art

The major objective of the acidification of manure is the suppression of the formation of methane and ammonia gases. Manure is collected and stored. The pH of manure is typically above 8 and contains biodegradable components. Collected manure therefore will readily become anaerobic and methane gas and ammonia gas is generated and emitted. The emissions of methane gas and ammonia gas must be prevented from an environmental point of view. The emissions of methane gas and ammonia gas are prevented most effectively by maintaining the pH of the manure between not higher than 4.5, preferably between 4 and 4.5. Thus, ammonia is fixed in the water phase as cations and the formation of methane is halted. The pH of the manure is maintained at mentioned values by acidification of the manure. In the case that the manure will be digested, acidification has the advantage that more methane is formed in the digestion process by the prevention of the formation of methane by acidification in the storage process, and the advantage that the part of ammonia that would be emitted as a gas is now stored as a nitrogen mineral in the digested manure for use as fertilizer.

The acidification of manure by adding acids is common knowledge. Nitric acid has been tested and used as an acid. Using nitric acid has the disadvantage of promoting denitrification reactions, leading nitrous oxide (N₂O) gas emissions and loss of valuable fertilizer which causes the pH to increase again sulphuric acid has been found as a useful acid to acidify manure, but will add more sulfur increasing the hydrogen sulphide (H₂S) content of the biogas. Organic acids do not have the disadvantage to add extra minerals to mentioned fertilizer that can be undesired. The costs of acidification of manure by adding acid in order to supress the methane and ammonia has prevented wide spread use of this method.

One method for the acidification of manure is described in EP 0612704, which is hereby incorporated by reference in its entirety. The method comprises adding acid producing bacteria to the manure. The acid producing bacteria are capable of surviving in manure by feeding on the substrates in manure. The substrates are converted to acids by mentioned bacteria and provide the reduction of the pH value of manure.

### BRIEF SUMMARY OF THE INVENTION

It is an object of the present invention to provide an improved method for the acidification of manure.

For example, in one embodiment according to the present invention, the method for the acidification of manure uses acidic transportable flow of an anaerobic digestion device and/or a flow of sulphuric and/or sulphurous acid from a device that removes hydrogen sulphide gas from biogas, said method comprising at least the following steps:

retrieving from mentioned anaerobic digestion device at least a part of the flow that is in any phase of a digestion process and/or a part of the flow from, and/or retrieving from said device sulphuric and/or sulphurous acid from a device that removes hydrogen sulphide gas from biogas from an anaerobic digestion device by chemical and/or biological oxidation to sulphuric acid, transporting said acidic flows to the manure, in order to significantly reduce emissions of methane gas and ammonia gas, by acidifying the manure. In this embodiment, the pH value of said flows being maximum 5.

In another embodiment according to the present invention, the method for acidification of manure includes using acidic transportable flow from the hydrolysis phase of anaerobic digestion of organic material, said method comprising the following steps:

retrieving an acidic flow from the hydrolysis phase of anaerobic digestion of organic material in an anaerobic digestion device, transporting the acidic flow to the manure, and allowing the acidic flow to be present in the manure long enough to acidify the manure, thereby reducing the emissions of methane gas and ammonia. In this embodiment, the acidic flow from the hydrolysis phase has a pH value of between 3 and 5.

Further, in this embodiment, the anaerobic digestion device digests the organic material to produce biogas, wherein excess hydrogen sulphide is produced as a result of the digestion of the organic material to produce biogas. The excess hydrogen sulphide is removed from the anaerobic digestion device, and is oxidized to sulphuric acid, and wherein the sulphuric acid is added as an acid to the manure for acidifying the manure.

In another embodiment according to the present invention, the method for acidification of manure includes using sulphuric acid, the method comprising the steps of:

retrieving hydrogen sulphide from an anaerobic digestion device, the device configured to convert organic material into biogas, oxidizing the hydrogen sulphide to sulphuric acid, transporting the sulphuric acid to the manure, allowing the sulphuric acid to be present in the manure long enough to acidify the manure, thereby reducing the emissions of methane gas and ammonia. In this embodiment, the pH of the sulphuric acid is between 2 and 3.

When manure is digested, acidification has the advantage that more methane is formed in the digestion process by the prevention of the formation of methane by acidification in the storage process, the advantage that the part of ammonia that would be emitted as a gas is now stored as a nitrogen mineral in the digested manure for use as fertilizer, and the advantage is that the manure has a pH value that is more preferable for digestion processes in the case the manure will be digested.

### DESCRIPTION OF ILLUSTRATIVE EMBODIMENTS

In accordance with various aspects of the present invention, a method for the acidification of manure is provided by an acidic flow of an anaerobic digestion device and/or the flow of sulphuric acid from a device that oxidates hydrogen sulfide gas (H₂S) in the biogas from an anaerobic digestion device to sulphuric acid.

The major objective of anaerobic digestion of organic material is the production of biogas. In anaerobic digestion, organic material, for example manure, animal fat or garden waste, is broken down to smaller molecules, such as for instance methane and carbon dioxide, in a number of different stages, substantially in the absence of air or any other source of oxygen. According to the invention any acidious flow that can be transported to the manure is to be used as an acid for the acidification of manure for the mentioned purposes. One example of an acidious flow of a digestion device is the flow from the hydrolysis phase. The hydrolysis phase is usually, not necessary, the first phase of anaerobic digestion of a mass of organic material.

In hydrolysis, the larger organic molecules, such as proteins, carbohydrates and fats are broken down by microbes to smaller molecules, such as acids. The flow from the hydrolysis phase typically, but not necessary, has a pH ranging from 3 to 5 The major product of an anaerobic digestion device is biogas. Biogas can contain an undesirable level of hydrogen sulphur. Hydrogen sulphur (H2S) causes corrosion to devices such as boilers and engines, when the biogas is used as a fuel. Hydrogen sulphur is oxydized chemically and/or biologically to sulphurous oxide, when it is removed from the biogas, forming sulphuric and/or sulphurous acid in a liquid flow. The sulphuric acid has a pH of typically, not necessary, between 2 to 3. The extra hydrogen sulphide (H2S) in the biogas can be removed again from the biogas, and chemically and/or biologically oxydized to sulphuric acid to be used as an acid for the acidification of manure.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method for the acidification of manure by using acidic transportable flow of an anaerobic digestion device and/or a flow of sulphuric and/or sulphurous acid from a device that removes hydrogen sulphide gas from biogas, said method comprising at least the following steps:
retrieving from mentioned anaerobic digestion device at least a part of the flow that is in any phase of a digestion process and/or a part of the flow from, and/or retrieving from said device sulphuric and/or sulphurous acid from a device that removes hydrogen sulphide gas from biogas from an anaerobic digestion device by chemical and/or biological oxidation to sulphuric acid,
transporting said acidic flows to the manure,
in order to significantly reduce emissions of methane gas and ammonia gas, by acidifying the manure.

2. The method according to claim 1, wherein the pH value of said flows being maximum 5.

3. A method for acidification of manure using acidic transportable flow from the hydrolysis phase of anaerobic digestion of organic material, said method comprising the following steps:
retrieving an acidic flow from the hydrolysis phase of anaerobic digestion of organic material in an anaerobic digestion device,
transporting the acidic flow to the manure, and
allowing the acidic flow to be present in the manure long enough to acidify the manure, thereby reducing the emissions of methane gas and ammonia.

4. The method according to 3, wherein the acidic flow from the hydrolysis phase has a pH value of between 3 and 5.

5. The method according to claim 3, wherein anaerobic digestion device digests the organic material to produce biogas.

6. The method according to claim 5, wherein excess hydrogen sulphide is produced as a result of the digestion of the organic material to produce biogas.

7. The method according to claim 6, wherein the excess hydrogen sulphide is removed from the anaerobic digestion device, and is oxidized to sulphuric acid, and wherein the sulphuric acid is added as an acid to the manure for acidifying the manure.

8. A method for acidification of manure using sulphuric acid, the method comprising the steps of:
retrieving hydrogen sulphide from an anaerobic digestion device, the device configured to convert organic material into biogas,
oxidizing the hydrogen sulphide to sulphuric acid,
transporting the sulphuric acid to the manure, and
allowing the sulphuric acid to be present in the manure long enough to acidify the manure, thereby reducing the emissions of methane gas and ammonia.

9. The method according to claim 8, wherein the pH of the sulphuric acid is between 2 and 3.
